(19) United States
(12) Patent Application Publication
(10) Pub. No.: US 2020/0247449 A1
(43) Pub. Date: Aug. 6, 2020

(54) TROLLEY ARRANGEMENT

(71) Applicant: SUPERCART SOUTH AFRICA (PTY) LTD, Durban (ZA)

(72) Inventor: Michael Castledine WOLFE, Durban (ZA)

(73) Assignee: SUPERCART SOUTH AFRICA (PTY) LTD, Durban (ZA)

(21) Appl. No.: 16/778,868

(22) Filed: Jan. 31, 2020

(30) Foreign Application Priority Data
Jan. 31, 2019 (ZA) 2019/00653

(51) Int. Cl. B62B 3/14; B62B 3/18; B62B 3/00

(52) U.S. Cl. CPC B62B 3/1496; B62B 3/184; B62B 3/005; B62B 3/1468; B62B 3/1472

(57) ABSTRACT

A trolley arrangement is provided comprising a chassis from which a plurality of upwardly extending, rear support posts extend. An upper support frame is fitted to, and extends away from, the rear support posts, the upper support frame being fitted along the length of the support posts so that upper portions of the support posts extend upwardly, so as to protrude, from the upper support frame, the upper support frame comprising a peripheral bar component. A basket can be secured to the upper portions of the support posts, the basket being supported on top of the upper support frame once assembled. The basket comprises a corresponding plurality of elongate corner side wails that are arranged to be adjacent the upwardly extending support posts so that each post is arranged to abut against one of the upwardly extending corner side walls in use.

### FIELD OF THE INVENTION

THIS INVENTION relates to a trolley arrangement, and in particular to an arrangement for facilitating the securing of a trolley basket to an underlying chassis,

There are typically many ways of securing a trolley basket to a chassis In one version, the chassis includes a plurality of posts that extends upwardly from a mobile chassis, with the basket then being connected to these posts in any one of a number of known ways. In one such known way, an elongate sleeve extends along the length of the corners of the basket to receive the connecting posts extending from the chassis. These posts may then be secured in position within the sleeve. However, because of the snug fit required between the post and the sleeve, the assembling of this type of trolley arrangement can be difficult and time consuming.

It is thus an aim of the present invention to provide a trolley arrangement that addresses at least some of the above shortcomings.

### SUMMARY OF THE INVENTION

According to a first aspect of the invention there is provided a trolley arrangement comprising:
a chassis from which a plurality of upwardly extending, rear support posts extend;
an upper support frame fitted to, and extending away from, the rear support posts, the upper support frame being fitted along the length of the support posts so that upper portions of the support posts extend upwardly, so as to protrude, from the upper support frame, the upper support frame comprising a peripheral bar component; and
a basket that can be secured to the chassis, and in particular, to the upper portions of the support posts, the basket being supported on top of the upper support frame once assembled, the basket comprising a corresponding plurality of elongate corner side walls that are arranged to be adjacent the upwardly extending support posts so that each post is arranged to abut against one of the upwardly extending corner side walls in use, the lower end of the basket defining a slot arrangement for snugly accommodating the adjacent portion of the peripheral bar component.

In an embodiment, the peripheral bar component is substantially rectangular in cross-section, extending vertically in use, with the slot arrangement accordingly also being rectangular. Typically, the slot arrangement comprises an inner member and an outer member, with the inner and outer members being arranged to straddle the peripheral bar component.

In an embodiment, support brackets are fitted to each of the support posts, with the ends of the support brackets being fitted with a transversely extending support bar to support the upper support frame.

In one version, the rear ends of he upper support frame are secured to the inner sides of the support posts, with a gap being defined between the support brackets and the rear ends of the upper support frame to accommodate the outer members of the slot arrangement.

In an embodiment, the upper support frame is substantially rectangular, with the peripheral bar component defining at least one, but typically two opposing, curved recesses proximate a front end of the upper support frame. The basket includes a base panel that defines the slot arrangement to accommodate the peripheral bar component of the upper support frame, to enable the basket to securely and snugly fit on top of the upper support frame. The slot arrangement of the basket has the same general shape and configuration as the upper support frame, so that the base panel also defines at least one, but typically two opposing, curved recesses proximate the end of the base panel of the basket so as to be in line with the corresponding curved recesses of the upper support frame.

In an embodiment, the basket further includes a pair of rear side walls extending upwardly from the base panel and a front wall provided along the length of the base panel so as to define a rear compartment and a front support tray, the front support tray including the curved recesses of the upper support frame and the base panel of the basket. An elongate slot or aperture may be defined in the front support tray, and the support tray may further include a plurality of stoppers, proximate the front edge of the front support tray.

In an embodiment, the rear compartment may include a divider wall, spaced apart from the front wall, to safely accommodate goods, such as bottles.

In an embodiment, the basket further includes a sleeve proximate the upper portion of each corner side wall, to receive the upper ends of the support posts.

In an embodiment, the trolley arrangement comprises a securing arrangement for securing each support post to a corresponding sleeve. Conveniently, the securing arrangement is used to also secure a back gate at a rear end of the basket. The securing arrangement comprises a fixing element that extends through aligned apertures defined in the sleeve, the support post, the corner side wall, and terminating in a securing element of the back gate.

In an embodiment, a handle bar extends between the pair of spaced apart sleeves.

In an embodiment, the chassis of the trolley arrangement includes a lower frame from which the upwardly extending, rear support posts extend. Wheels are fitted to the underside of the lower frame, with a base platform for carrying goods being fitted to, so as to be supported on top of, the lower frame.

According to a second aspect of the invention there is provided a basket for a trolley arrangement comprising a chassis from which a plurality of upwardly extending, rear support posts extend and an upper support frame fitted to, and extending away from, the rear support posts, the upper support frame, comprising a peripheral bar component, the basket being securable to the chassis, and in particular, the upper portions of the support posts, the basket being supported on top of the upper support frame once assembled, the basket comprising elongate corner side walls that are arranged to be adjacent the upwardly extending support posts so that each post is arranged to abut against one of the upwardly extending corner side walls in use, the lower end of the basket defining a slot arrangement for snugly accommodating the adjacent portion of the peripheral bar component.

In an embodiment, the peripheral bar component is substantially rectangular in cross-section, extending vertically in use, with the slot arrangement accordingly also being rectangular. Typically, the slot arrangement comprises an inner member and an outer member, with the inner and outer members being arranged to straddle the peripheral bar component.

In an embodiment, the upper support frame is substantially rectangular, with the peripheral bar component defining at least one, but typically two opposing, curved recesses proximate a front end of the upper support frame. The basket includes a base panel that defines the slot arrangement to accommodate the peripheral bar component of the upper support frame, to enable the basket to securely and snugly fit on top of the upper support frame. The slot arrangement of the basket has the same general shape and configuration as the upper support frame, so that the base panel also defines at least one, but typically two opposing, curved recesses proximate the end of the base panel of the basket so as to be in line with the corresponding curved recesses of the upper support frame.

In an embodiment, basket further includes a pair of rear side walls extending upwardly from the base panel and a front wall provided along the length of the base panel so as define a rear compartment and a front support tray, the front support tray including the curved recesses of the upper support frame and the base panel of the basket. An elongate slot or aperture may be defined in the front support tray.

In an embodiment, the rear compartment may include a divider wall, spaced apart from the front wall, to facilitate the safe holding of bottles.

In an embodiment, the basket further includes a sleeve proximate the upper portion of each corner side wall, to receive the upper ends of the support posts.

According to a third aspect of the invention there is provided a basket for a trolley arrangement comprising a chassis from which a plurality of upwardly extending, rear support posts extend, the basket being securable to the chassis, and in particular, the upper portions of the support posts, the basket comprising elongate corner side walls that are arranged to be adjacent the upwardly extending support posts so that each post is arranged to abut against one of the upwardly extending corner side walls in use.

In an embodiment, the basket includes a base panel that defines at least one, but typically two opposing, curved recesses proximate the end of the base panel of the basket.

In an embodiment, the basket further includes a pair of rear side walls extending upwardly from the base panel and a front wall provided along the length of the base panel so as define a rear compartment and a front support tray, the front support tray including the curved recesses of the base panel of the basket.

In an embodiment, the rear compartment includes a divider wall, spaced apart from the front wall, to facilitate the safe holding of bottles.

In an embodiment, the basket further includes a sleeve proximate the upper portion of each corner side wall, to receive the upper ends of the support posts.

### BRIEF DESCRIPTION OF THE DRAWINGS

FIG. 1 shows a first perspective view of a trolley arrangement according to a first embodiment of the present invention;

FIG. 2 shows a second perspective view of the trolley arrangement shown in FIG. 1;

FIG. 3 shows a side view of the trolley arrangement shown in FIGS. 1 and 2, and two detailed front views of the trolley taken partly along line A-A;

FIG. 4 shows an exploded perspective view of the trolley arrangement shown in FIGS. 1 and 2;

FIG. 6 shows a detailed perspective view of a basket securing arrangement shown in FIG. 4;

FIG. 6 shows a rear view corresponding substantially to the exploded perspective view shown in FIG. 4;

FIG. 7 shows a detailed view of the basket securing arrangement shown in FIG. 6; and

FIG. 8 shows a perspective view of the trolley arrangement, in use.

FIG. 9 shows a first perspective view of a trolley arrangement according to a second embodiment of the present invention;

FIG. 10 shows a second perspective view of the trolley arrangement shown in FIG. 9;

FIG. 11 shows an exploded perspective view of the trolley arrangement shown in FIGS. 9 and 10;

FIG. 12 shows a bottom perspective view of a basket used in the trolley arrangement shown in FIGS. 9 and 10; and

FIG. 13 shows a side view of the trolley arrangement shown in FIGS. 9 and 10, and two detailed front views of the trolley taken partly along line B-B.

### DETAILED DESCRIPTION OF THE INVENTION

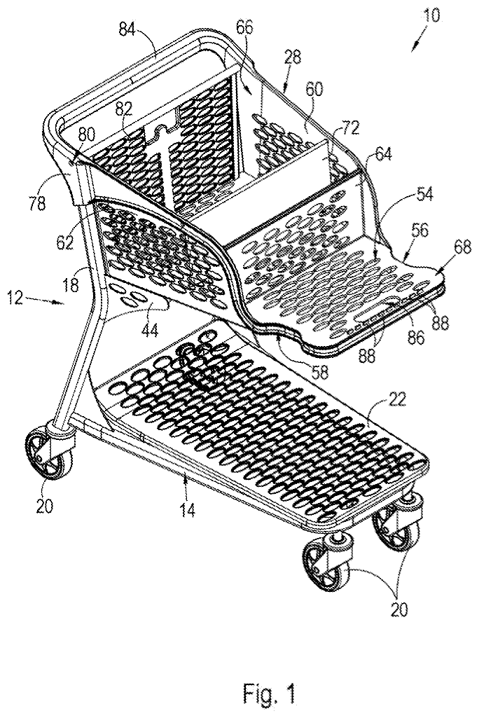

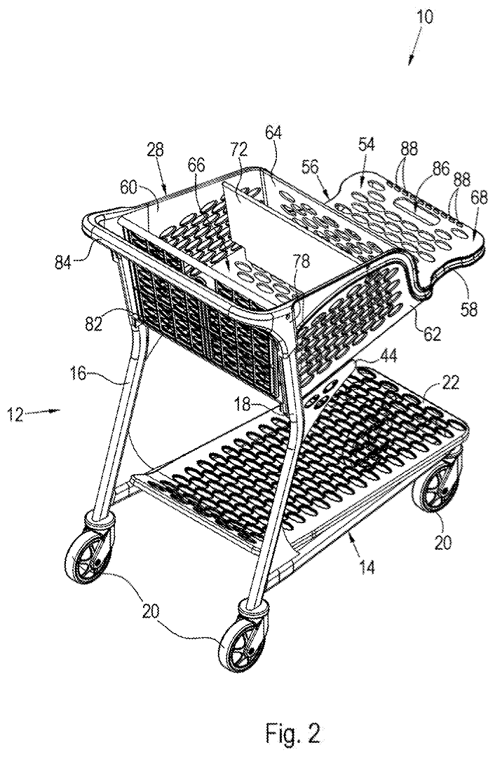

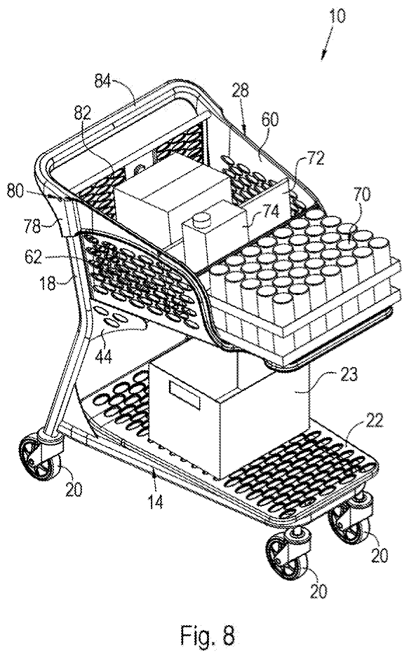

Referring first to FIGS. 1 to 8 of the drawings, a first version of a trolley arrangement 10 comprises a chassis 12 including a lower frame 14 from which a pair of upwardly extending, rear support posts 16, 18 extend. Wheels 20 are fitted to the underside of the lower frame 14, with a base platform 22 for carrying goods 23 (as shown in FIG. 8) being fitted to, so as to be supported on top of, the lower frame 14.

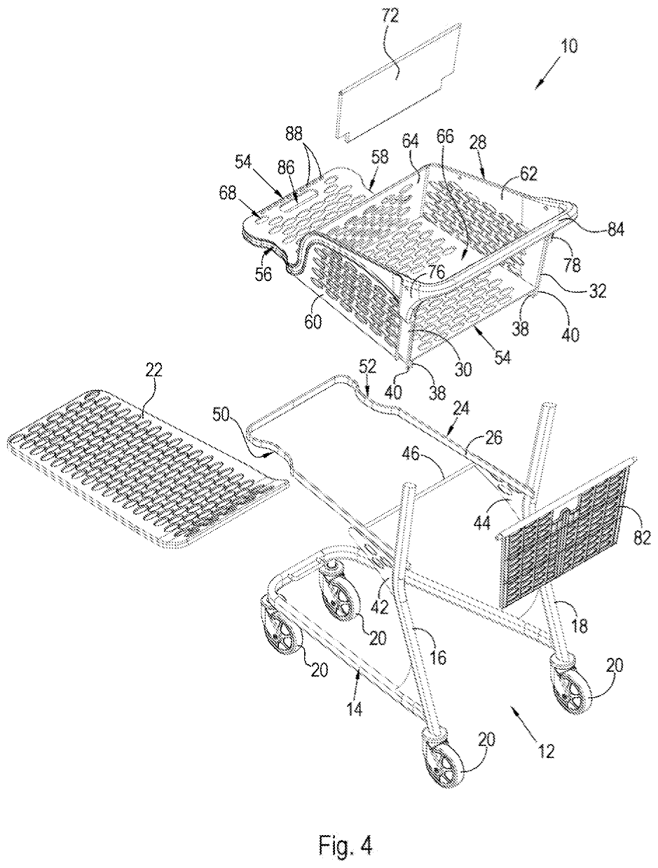

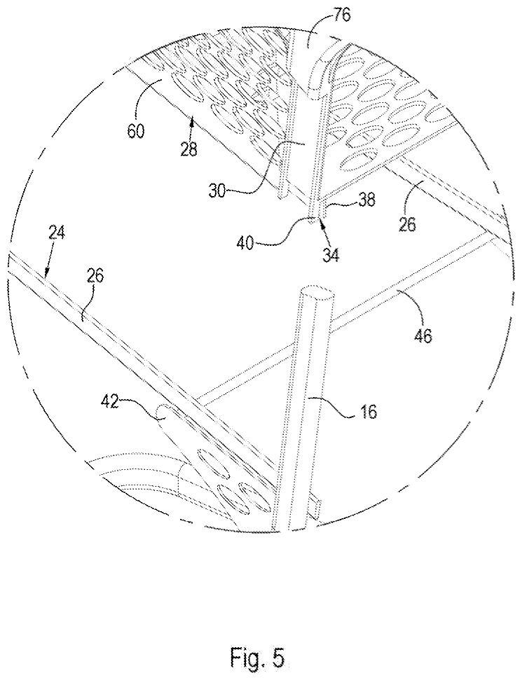

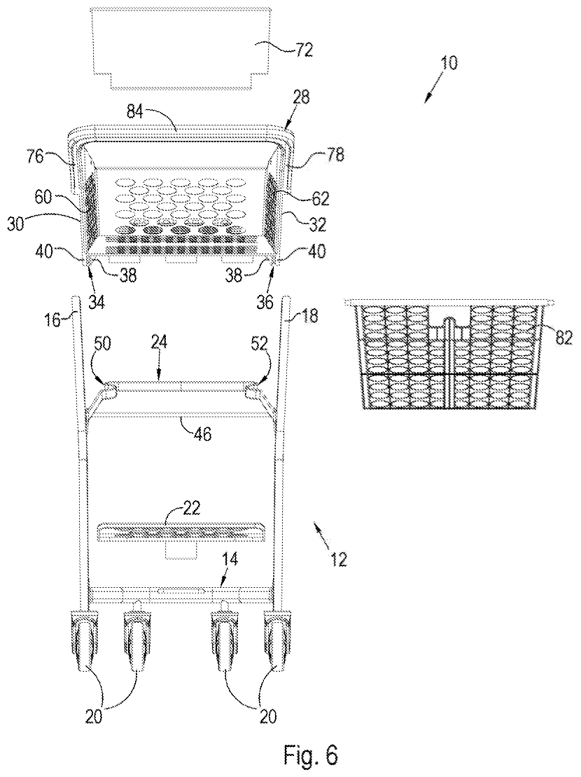

The chassis 12 further includes an upper support frame 24 fitted to, and extending away from, the rear support posts 16, 18; the upper support frame 24 extends substantially parallel to the lower frame 14. The upper support frame 24 is fitted along the length of the support posts 16, 18 so that upper portions of the support posts 16, 18 extend upwardly, so as to protrude, from the upper support frame 24. The upper support frame 24 comprises a peripheral bar component 26, as best shown in FIGS. 4 and 6.

The trolley arrangement 10 further comprises a basket 28 that can be secured to the chassis 12, and in particular, to the upper portions of the support posts 16, 18. The basket 28 is supported on top of the upper support frame 24 once assembled.

As best shown in FIGS. 4 to 6, the basket 28 comprises a pair of elongate corner side walls 30, 32 that are arranged to be adjacent the upwardly extending support posts 16, 18 so that each post 16, 18 is arranged to abut against upwardly extending corner side walls 30, 32, respectively, in use.

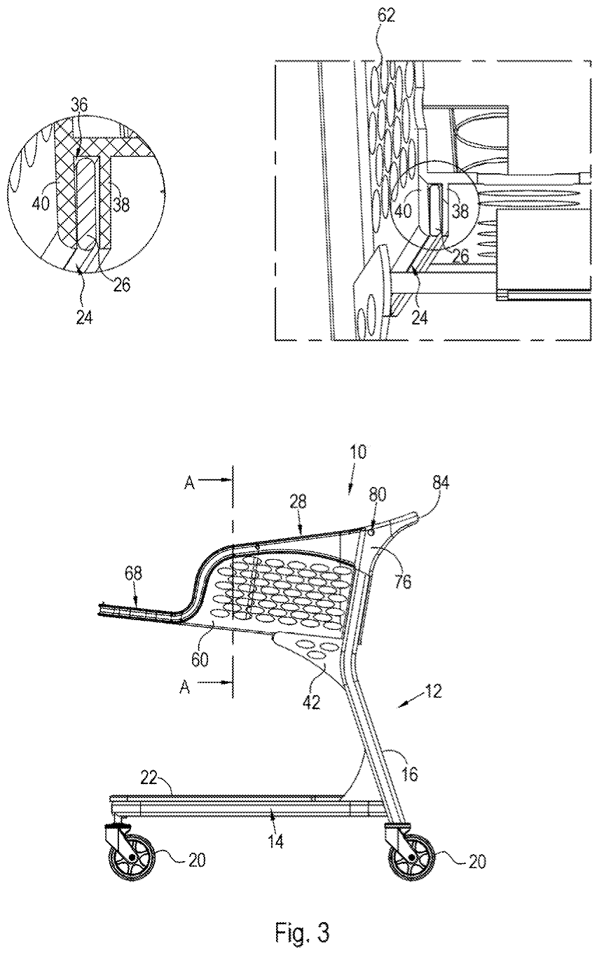

The lower ends of each side wall 30, 32 define slot arrangements 34, 36, as best shown in FIGS. 3, 5 and 7, for snugly accommodating the adjacent portion of the peripheral bar component 26.

In an embodiment, the peripheral bar component 26 is substantially rectangular in cross-section, extending vertically in use, with the slot arrangements 34, 36 accordingly also being rectangular. Typically, each slot arrangement 34, 36 comprises an inner member 38 and an outer member 40, with the inner and outer members 38, 40 being arranged to straddle the peripheral bar component 26.

Support brackets 42, 44 are fitted to each of the support posts 16, 18, with the ends of the support brackets 42, 44 being fitted with a transversely extending support bar 46 to support the upper support frame 24.

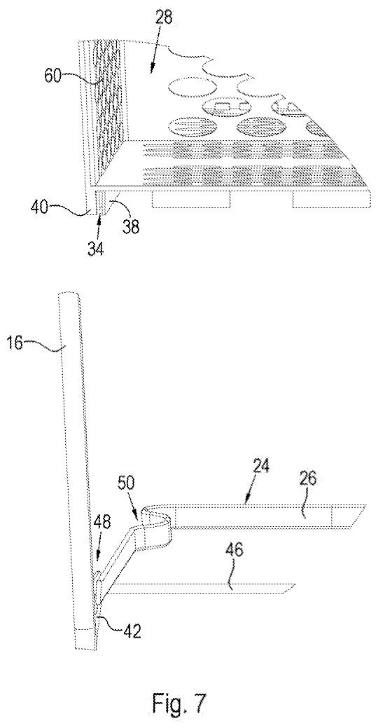

In an embodiment, the rear ends of the upper support frame 24 are secured to the inner sides of the support posts 16, 18, with a gap 48 (best shown in FIG. 7) being defined between the support brackets 42, 44 and the rear ends of the upper support frame 24 to accommodate the outer members 40 of the slot arrangements 34, 36.

The upper support frame 24 itself is substantially rectangular, with the peripheral bar component 26 defining at least one, but typically two opposing, curved recesses 50, 52 proximate the end of the upper support frame 24. The basket 28 includes a base panel 54 that sits on top of the upper support frame 24, and has the same general shape and configuration as the upper support frame 24, so that the base panel 54 also defines at least one, but typically two opposing, curved recesses 56, 58 proximate the end of the base panel 54 of the basket 28 so as to be in line with the corresponding curved recesses 50, 52 of the upper support frame 24.

In an embodiment, the basket 28 further includes a pair of rear side walls 60, 62 extending upwardly from the base panel 54, and a front wall 64 provided along the length of the base panel 54 so as define a rear compartment 66 and a front support tray or tongue 68. The front support tray 68 includes the curved recesses 50, 52 and 56, 58 of the upper support frame 24 and the base panel 54, respectively, of the basket 28.

The front support tray 68 defines an elongate slot or aperture 86 to facilitate handling. The front support tray 68 further includes a plurality of stopper elements 88, proximate the front edge of the front support tray 68.

The front support tray 68 is ideal for carrying at least one case of canned or bottled drinks 70, as best in FIG. 8, with the curved recesses 50, 52, 56, 58 facilitating easy placement on top of, and removal from, the front support tray 68.

In an embodiment, the rear compartment 66 may include a solid divider wall 72, spaced apart from the front wall 64, to facilitate the safe holding of elongate container 74 or bottles, as shown in FIG. 8.

In an embodiment, the basket 28 further includes a pair of sleeves 76, 78 proximate the upper portion of each corner side wall 30, 32, respectively, to receive the upper ends of the support posts 16, 18. A securing arrangement 80 is provided to secure each support post 16, 18 to a corresponding sleeve 76, 78, respectively. Conveniently, the securing arrangement 80 is used to also secure a back gate 82 at a rear end of the basket 28. The securing arrangement 80 comprises a fixing element that extends through aligned apertures defined in the sleeves 76, 78, the support posts 16, 18, the corner side wall 30, 32, and terminating in a securing element of the back gate 82.

In an embodiment, a handlebar 84 extends between the pair of spaced apart sleeves 76, 78.

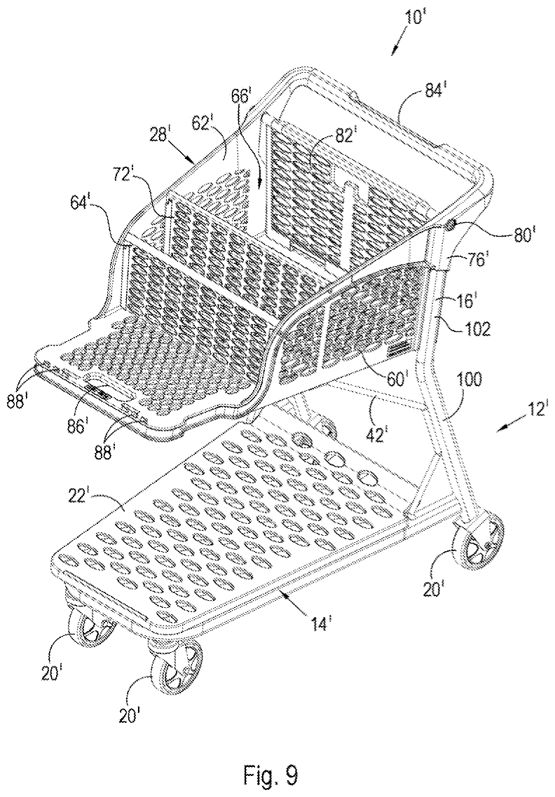

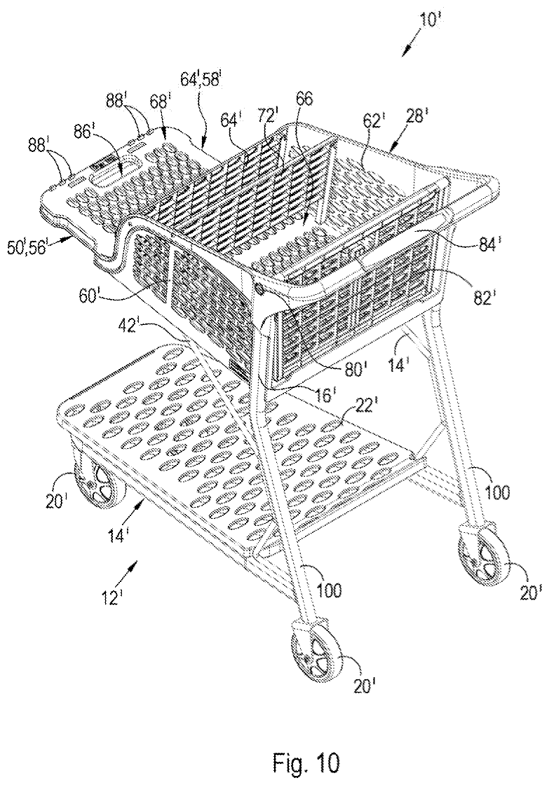

Turning now to FIGS. 9 to 13 of the drawings, a second version of a trolley arrangement 10′ is shown. The majority of the components of this version are the same (or similar) to the components described above with reference to FIGS. 1 to 8; thus, similar reference numerals are used for similar components (but annotated with a “′”), and will not be described again.

The trolley component 10′ comprises a chassis 12′ including a lower frame 14′ from which a pair of upwardly extending, rear support posts 16′, 18′ extend. Wheels 20′ are fitted to the underside of the lower frame 14′, with a base platform 22′ for carrying goods being fitted to, so as to be supported on top of, the lower frame 14′. Each support post 16′, 18′ has a forwardly angled lower portion 100 and a rearwardly angled upper potion 102, to define a relatively flat configuration when viewed from the side.

The chassis 12′ further includes an upper support frame 24′ fitted to, and extending away from, the rear support posts 16, 18′. The upper support frame 24′ is fitted along the length of the support posts 16′, 18′, typically at a lower end of the angled upper potion 102.

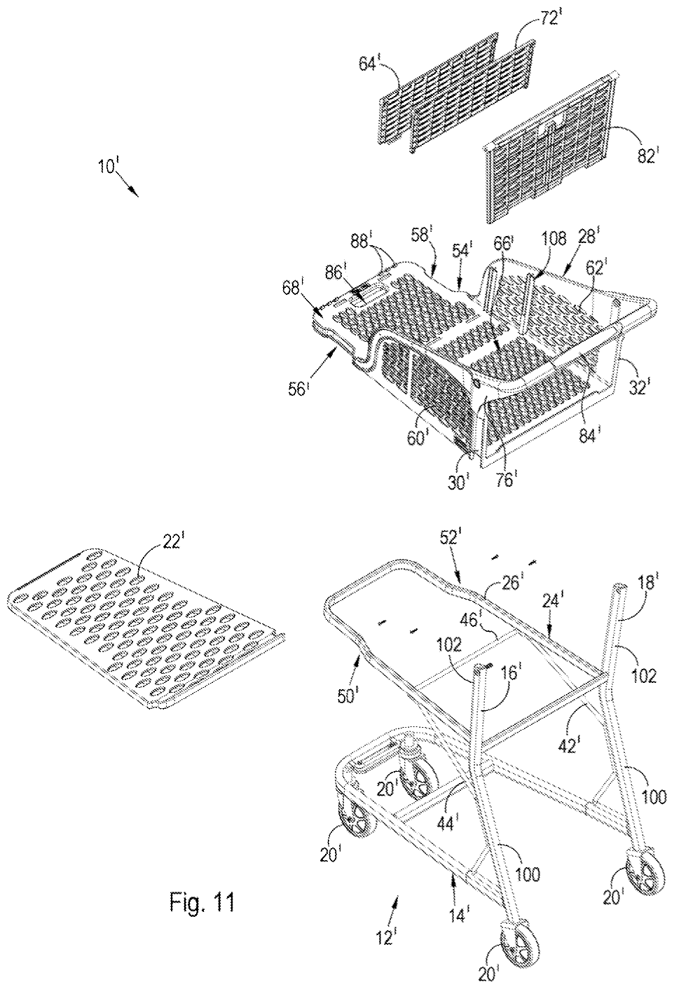

The upper support frame 24′ comprises a peripheral bar component 26′ as best shown in FIG. 11.

The trolley arrangement 10′ further comprises a basket 28′ that can be secured to the chassis 12′, and in particular, to the upper portions of the support posts 16, 18. In this regard, the basket 28′ includes a pair of sleeves 76′, 78′ proximate the upper portion of elongate corner side walls 30′, 32′, respectively, to receive the upper ends of the support posts 16′, 18′. The pair of elongate corner side walls 30′, 32′ are arranged to be adjacent the upwardly extending support posts 16′, 18′ so that each post 16′, 18′ is arranged to abut against upwardly extending corner side walls 30, 32, respectively, in use.

A securing arrangement 80′ is provided to secure each support post 16′, 18′ to a corresponding sleeve 76′, 78′, respectively, as described above. Thus, the securing arrangement 80′ is also used to also secure a back gate 82′ at a rear end of the basket 28′.

A handlebar 4′ extends between the pair of spaced apart sleeves 76′, 78′.

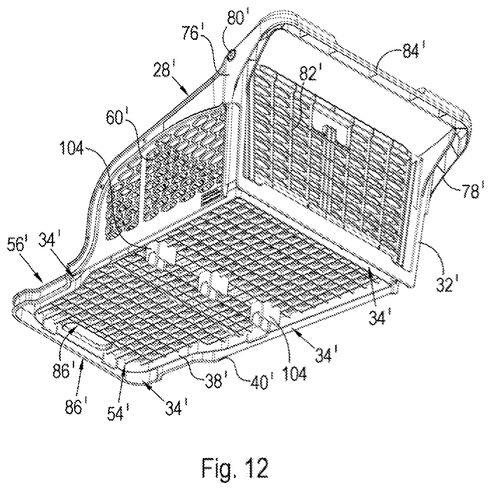

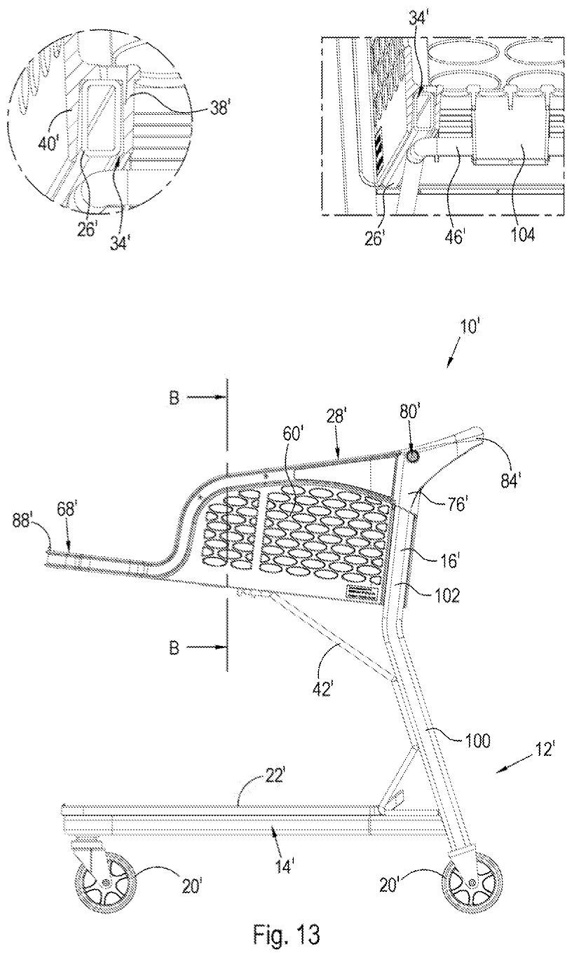

The basket 28′ is supported on top of the upper support frame 24′ once assembled. In particular, the bottom side of the basket 28′, as shown in FIGS. 12 and 13, defines a, substantially continuous, peripheral slot or channel arrangement 34′ that extends around the outside of the bottom side of the basket 28′. The slot arrangement 34′ is arranged to snugly accommodate the peripheral bar component 26′ of the upper support frame 24′. The slot arrangement 34′ is defined between an inner member 38 and an outer member 40′, with the inner and outer members 38′, 40′ accordingly being arranged to straddle the peripheral bar component 26′.

The peripheral bar component 26′ is substantially cylindrically rectangular in cross-section, as shown in FIG. 13.

Support brackets 42′, 44′ are fitted to each of the support posts 16′, 18′, with the upper ends of the support brackets 42′, 44′ being fitted with a transversely extending support bar 46′ to support the upper support frame 24. The lower ends of the support brackets 42′, 44′ are secured to the lower frame 14′. In one version, the support bar 46′ is also arranged to securely accommodate clips 104 fitted to the bottom side of the basket 28′. Instead of the clips 104, self-tapping screws may be used to fix the basket 28′ to the upper support frame 24′.

Again, the upper support frame 24′ itself is substantially rectangular, with the peripheral bar component 26′ defining two opposing, curved recesses 50′, 52′ proximate the end of the upper support frame 24′. The base panel 54′ of the basket 28′ also has the same general shape and configuration as the upper support frame 24′, so as to be in line with the corresponding curved recesses 50′, 52′ of the upper support frame 24′ (as described above with reference to the slot arrangement 34′).

In an embodiment, the basket 28′ further includes a pair of rear side walls 60′, 62′ extending upwardly from the base panel 54′, and a front wall 64′ provided along the length of the base panel 54′ so as define a rear compartment 66′ and a front support tray or tongue 68′. The front support tray 68′ includes the curved recesses 50′, 52′ and 56′, 58′ of the upper support frame 24′ and the base panel 54′, respectively, of the basket 28′.

The front support tray 68′ defines an elongate slot or aperture 86′ to facilitate handling. The front support tray 68′ further includes a plurality of stopper elements 88′, proximate the front edge of the front support tray 68′.

In an embodiment, the rear compartment 66′ may include a perforated divider wall 72′, spaced apart from the front wall 64′, to facilitate the safe holding of elongate containers.

The rear side walls 60′, 62′ are fitted with slotted holders 106, 108, between which the front wall 64′ and the divider wall 72′ extend, respectively.

1. A trolley arrangement comprising:
a chassis from which a plurality of upwardly extending, rear support posts extend;
an upper support frame fitted to, and extending away from, the rear support posts, the upper support frame being fitted along the length of the support posts so that upper portions of the support posts extend upwardly, so as to protrude, from the upper support frame, the upper support frame comprising a peripheral bar component; and
a basket that can be secured to the upper portions of the support posts, the basket being supported on top of the upper support frame once assembled, the basket comprising a corresponding plurality of elongate corner side walls that are arranged to be adjacent the upwardly extending support posts so that each post is arranged to abut against one of the upwardly extending corner side walls in use, the lower end of the basket defining a slot arrangement for snugly accommodating an adjacent portion of the peripheral bar component.

2. The trolley arrangement of claim 1, wherein the peripheral bar component is substantially rectangular in cross-section, extending vertically in use, with the slot arrangement accordingly also being rectangular, with the slot arrangement comprising an inner member and an outer member, with the inner and outer members being arranged to straddle the peripheral bar component.

3. The trolley arrangement of claim 1, wherein support brackets are fitted to each of the support posts, with the ends of the support brackets being fitted with a transversely extending support bar to support the upper support frame.

4. The trolley arrangement of claim 1, wherein the upper support frame is substantially rectangular, with the peripheral bar component defining two opposing, curved recesses proximate a front end of the upper support frame.

5. The trolley arrangement of claim 4, wherein the basket includes a base panel that defines the slot arrangement to accommodate the peripheral bar component of the upper support frame, to enable the basket to securely and snugly fit on top of the upper support frame.

6. The trolley arrangement of claim 5, wherein the slot arrangement of the basket has the same shape and configuration as the upper support frame, so that the base panel also defines two opposing, curved recesses proximate the front end of the base panel of the basket so as to be in line with the corresponding curved recesses of the upper support frame.

7. The trolley arrangement of claim 6, wherein the basket further includes a pair of rear side walls extending upwardly from the base panel and a front wall provided along the length of the base panel so as to define a rear compartment and a front support tray, the front support tray including the curved recesses of the upper support frame and the base panel of the basket.

8. The trolley arrangement of claim 7, wherein an elongate slot or aperture is defined in the front support tray, and the support tray may further include a plurality of stoppers, proximate the front edge of the front support tray, with the rear compartment including a divider wall, spaced apart from the front wall, to safely accommodate goods.

9. The trolley arrangement of claim 1, wherein the basket includes a sleeve proximate the upper portion of each corner side wall, to receive the upper ends of the support posts.

10. The trolley arrangement of claim 9, wherein the trolley arrangement comprises a securing arrangement for securing each support post to a corresponding sleeve, the securing arrangement being used to secure a back gate at a rear end of the basket, the securing arrangement comprising a fixing element that extends through aligned apertures defined in the sleeve, the support post, the corner side wall, and terminating in a securing element of the back gate.

11. The trolley arrangement of claim 1, wherein the chassis of the trolley arrangement includes a lower frame from which the upwardly extending, rear support posts extend, with wheels being fitted to the underside of the lower frame, with a base platform for carrying goods being fitted to, so as to be supported on top of, the lower frame.

12. A basket for a trolley arrangement comprising a chassis from which a plurality of upwardly extending, rear support posts extend and an upper support frame fitted to, and extending away from, the rear support posts, the upper support frame comprising a peripheral bar component, the basket being securable to upper portions of the support posts, the basket being supported on top of the upper support frame once assembled, the basket comprising elongate corner side walls that are arranged to be adjacent the upwardly extending support posts so that each post is arranged to abut against one of the upwardly extending corner side walls in use, the lower end of the basket defining a slot arrangement for snugly accommodating the adjacent portion of the peripheral bar component.

13. The basket of claim 12, wherein the peripheral bar component is substantially rectangular in cross-section, extending vertically in use, with the slot arrangement accordingly also being rectangular.

14. The basket of claim 13, wherein the slot arrangement comprises an inner member and an outer member, with the inner and outer members being arranged to straddle the peripheral bar component.

15. The basket of claim 12, wherein the upper support frame is substantially rectangular, with the peripheral bar component defining two opposing, curved recesses proximate a front end of the upper support frame.

16. The basket of claim 15, wherein the basket includes a base panel that defines the slot arrangement to accommodate the peripheral bar component of the upper support frame, to enable the basket to securely and snugly fit on top of the upper support frame.

17. The basket of claim 16, wherein the slot arrangement of the basket has the same shape and configuration as the upper support frame, so that the base panel also defines two opposing, curved recesses proximate the end of the base panel of the basket so as to be in line with the corresponding curved recesses of the upper support frame.

18. The basket of claim 17, wherein the basket further includes a pair of rear side walls extending upwardly from the base panel and a front wall provided along the length of the base panel so as define a rear compartment and a front support tray, the front support tray including the curved recesses of the upper support frame and the base panel of the basket.

19. The basket of claim 18, wherein an elongate slot or aperture is defined in the front support tray, with the rear compartment include a divider wall, spaced apart from the front wall, to facilitate the safe holding of bottles.

20. The basket of claim 12, wherein the basket includes a sleeve proximate the upper portion of each corner side wall, to receive the upper ends of the support posts.
